(19) United States
(12) Patent Application Publication
(10) Pub. No.: US 2025/0101266 A1
(43) Pub. Date: Mar. 27, 2025

(54) High Bio-Content Polyurethane Hot Melt Adhesive Composition

(71) Applicant: Henkel AG & Co. KGaA, Duesseldorf (DE)

(72) Inventors: Rhiannon Ford Batchelor, Dormagen (DE); Dongmei Shen, Shanghai (CN); Bingbing Guo, Shanghai (CN); Adrian Brandt, Essen (DE); Patrick Gawlik, Duesseldorf (DE); Christian Holtgrewe, Duesseldorf (DE)

(21) Appl. No.: 18/725,166

(22) PCT Filed: Jan. 13, 2022
(86) PCT No.: PCT/CN2022/071706

§ 371 Date: Jun. 28, 2024

(51) Int. Cl. C09J 7/35; C09J 175/06

(52) U.S. Cl. CPC C09J 7/35; C09J 175/06; C09J 2301/304

(57) ABSTRACT

The present invention provides a high bio-content polyurethane hot melt adhesive composition comprising: at least one polyurethane prepolymer obtained from the reaction of a) at least one bio-based solid crystalline polyester polyol; b) at least one bio-based solid amorphous polyester polyol, and/or at least one bio-based liquid amorphous polyester; and c) at least one polyisocyanate; in a presence of a catalyst, wherein the adhesive composition contains more than 50% by weight of bio-based material, based on the total weight of the adhesive composition. The present invention also provides a method for preparing the high bio-content polyurethane hot melt adhesive composition, an electronic device obtained with the high bio-content polyurethane hot melt composition, and a use of the high bio-content polyurethane hot melt composition in manufacturing an electronic device.

### TECHNICAL FIELD

The present invention relates to a high bio-content polyurethane hot melt adhesive composition, a method for preparing the high bio-content polyurethane hot melt adhesive composition, an electronic device obtained with the high bio-content polyurethane hot melt composition, and a use of the high bio-content polyurethane hot melt composition in manufacturing an electronic device.

### BACKGROUND OF THE INVENTION

Polyurethane hot melt adhesives are long-established and widespread. In the context of industrial applications, polyurethane hot melt adhesives can be solid at room temperature, melt to a viscous liquid when heated to a moderate temperature, and applied to substrate to be bonded. The molten adhesive composition then cools and solidifies to form initial bond to the substrate. It can further react with moisture to form crosslinking structure and achieve high final strength. Such adhesives consist of a polyol component and an isocyanate component having a functionality of two or more. For numerous applications, these adhesives are preferred over other adhesives, since the adhesive bonds produced using them have outstanding bond strength, flexibility, and resistance to shock and fatigue.

Although polyurethane hot melt adhesives provide outstanding adhesive bonds in numerous fields of use, the adhesives of this type that have been known to date are unsuited to the structural adhesive bonding of plastics or metals workpieces, on account of their lack of adequate impact toughness, in particularly, for manufacturing electronic applications that required fast curing, the cured adhesive is difficult to achieve high initial cross tensile strength and outstanding impact resistance simultaneously.

Polyurethane hot melt adhesives consist of a polyol component and a polyisocyanate having a functionality of two or more. Usually, polyols on the basis of petrochemical raw materials are used for the synthesis of these polyurethane compositions. An increasing customer demand for sustainably sourced materials and the growing push for industry to incorporate more sustainable practices lead to a need for adhesive products to contain increased bio-based content. The challenge arises in that the performance of the adhesive must not be negatively affected by the increase in bio-content and the limited toolbox of bio-based raw materials.

In view of the above, it would be desirable to provide a high bio-content polyurethane hot melt adhesive composition, wherein the adhesive composition contains more than 50% by weight of bio-based material, based on the total weight of the adhesive composition; at the same time, such a high bio-content polyurethane hot melt adhesive composition exhibit excellent bonding strength and good impact resistance.

### SUMMARY OF THE INVENTION

A first object of the invention is to provide a high bio-content polyurethane hot melt adhesive composition comprising:
at least one polyurethane prepolymer obtained from the reaction of
   a) at least one bio-based solid crystalline polyester polyol;
   b) at least one bio-based solid amorphous polyester polyol, and/or at least one bio-based liquid amorphous polyester; and
   c) at least one polyisocyanate;
in a presence of a catalyst,
wherein the adhesive composition contains more than 50% by weight of bio-based material, based on the total weight of the adhesive composition.

Another object of the invention is to provide a method for preparing a high bio-content polyurethane hot melt adhesive composition according to any of the claims 1 to 12, comprising the steps:
(i) adding all the polyester polyols and optional (meth)acrylic resins, and melting and mixing them until homogeneous and free of moisture;
(ii) adding at least one polyisocyanate, and mixing the mixture obtained under vacuum at 80° C. to 120° C. until the reaction is completed; and
(iii) adding catalyst and optional additives, and stirring the mixture at 80° C. to 120° C. until homogeneous.

Yet another object of the invention is to provide an electronic device obtained with the high bio-content polyurethane hot melt composition according to the present invention.

Yet another object of the invention is to provide a use of the high bio-content polyurethane hot melt composition according to the present invention in manufacturing an electronic device.

As compared with the polyurethane hot melt adhesive compositions in the prior art, the high bio-content polyurethane hot melt adhesive composition according to the present invention contains more than 50% by weight of bio-based material, based on the total weight of the adhesive composition, at the same time exhibit excellent bonding strength and good impact resistance.

### DETAILED DESCRIPTION OF THE INVENTION

It is to be understood by one of ordinary skill in the art that the present invention is a description of exemplary embodiments only and is not intended as limiting the broader aspects of the present invention. Each aspect so described may be combined with any other aspect or aspects unless clearly indicated to the contrary. In particular, any feature indicated as being preferred or advantageous may be combined with any other feature or features indicated as being preferred or advantageous.

Unless specified otherwise, in the context of the present invention, the terms used are to be construed in accordance with the following definitions.

Unless specified otherwise, as used herein, the terms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements, or process steps.

The term “at least one” or “one or more” used herein to define a component refers to the type of the component, and not to the absolute number of molecules. For example, “one or more polyols” means one type of polyol or a mixture of a plurality of different polyols.

The term “amorphous” used herein means having no melt transition when measured using Differential Scanning Calorimetry (DSC).

The term “crystalline” used herein means having a melt transition when measured using Differential Scanning Calorimetry (DSC).

The term “room temperature” as used herein refers to a temperature of about 20° C. to about 25° C., preferably about 25° C.

By the term “bio-based” is meant herein a raw material, which is derived from the renewable sources (and is not petrol based). However, it is noted that the term does not refer to the production process of the materials, only to the source where they are derived from. ASTM D 6866 for example is used to determine the bio-based content of the materials.

Unless specified otherwise, the recitation of numerical end points includes all numbers and fractions subsumed within the respective ranges, as well as the recited end points.

All references cited in the present specification are hereby incorporated by reference in their entirety.

The molecular weights refer to number average molecular weights (Mₙ), unless otherwise stipulated. All molecular weight data refer to values obtained by gel permeation chromatography (GPC), unless otherwise stipulated, e.g., according to DIN 55672.

In this context, the glass transition temperature (Tg) or the melting point of a specific polymer is determined using DSC according to DIN 53 765.

The softening point mentioned herein is determined by using Ring and Ball method according to DIN ISO 4625.

Unless otherwise defined, all terms used in the present invention, including technical and scientific terms, have the meaning as commonly understood by one of the ordinary skilled in the art to which this invention belongs.

In one aspect, the present disclosure is generally directed to a high bio-content polyurethane hot melt adhesive composition comprising:
at least one polyurethane prepolymer obtained from the reaction of
   a) at least one bio-based solid crystalline polyester polyol;
   b) at least one bio-based solid amorphous polyester polyol, and/or at least one bio-based liquid amorphous polyester; and
   c) at least one polyisocyanate;
in a presence of a catalyst,
wherein the adhesive composition contains more than 50% by weight of bio-based material, based on the total weight of the adhesive composition.

### Polyurethane Prepolymer

According to the present invention, the high bio-content polyurethane hot melt adhesive composition comprises at least one polyurethane prepolymer obtained from the reaction of a) at least one bio-based solid crystalline polyester polyol; b) at least one bio-based solid amorphous polyester polyol, and/or at least one bio-based liquid amorphous polyester; and c) at least one polyisocyanate; in a presence of a catalyst.

In some embodiments, the polyurethane prepolymer has a number average molecular weight (Mn) of from about 5,000 to about 30,000 g/mol, preferably from about 8,000 to about 20,000 g/mol.

### a) Bio-Based Solid Crystalline Polyester Polyol

According to the present invention, the bio-based solid crystalline polyester polyol can be derived from a reaction mixture comprising at least one polyacid or its derivative and at least polyol. Preferably, the derivative of the polyacid is the carboxylic anhydride and/or ester of the polyacid. More preferably, the polyacid is a diacid, which is preferably selected from the group consisting of succinic acid, azelaic acid, sebacic acid, dodecane dioic acid, dimer fatty acid, 2,5-furandicarboxylic acid, adipic acid and combinations thereof. In an preferred embodiment of the present invention, the polyol is a diol, which is preferably selected from the group consisting of ethylene glycol, diethylene glycol, 1,2-propylene glycol, 1,3-propylene glycol, 1,4-butanediol, 1.6-hexane diol, isosorbide and combinations thereof. Most preferably, the bio-based solid crystalline polyester polyol is derived from a reaction mixture comprising one long chain diacid with an even C number and one diol with an even C number.

In a preferred embodiment of the present invention, the bio-based solid crystalline polyester polyol has a melting point of from about 10 to about 110° C., preferably from about 30 to about 90° C., more preferably about 45 to about 80° C. In another preferred embodiment of the present invention, the bio-based solid crystalline polyester polyol has a number average molecular weight higher than about 1000 g/mol, preferably from about 2000 to about 8000 g/mol, more preferably about 3700 to about 6500 g/mol.

Suitable commercially available bio-based crystalline polyester polyols are sold under the trade name of Dynacoll Terra 7750 (Evonik), Bio-Hoopol 11003, Bio-Hoopol 11520 or Bio-Hoopol 12930 (Synthesia).

In a preferred embodiment of the present invention, the bio-based solid crystalline polyester polyol is present in an amount of about 10 to about 40% by weight, preferably about 15 to about 35% by weight, based on the total weight of the adhesive composition.

b) Bio-Based Solid Amorphous Polyester Polyol and/or Bio-Based Liquid Amorphous Polyester Polyol

According to the present invention, the bio-based solid amorphous polyester polyol is derived from a reaction mixture comprising at least one anhydrohexitol and at least one polyfunctional carboxylic acid. Preferably, the bio-based solid amorphous polyester polyol is derived from a reaction mixture comprising at least one anhydrohexitol and at least one polyfunctional carboxylic acid. More preferably, the bio-based solid amorphous polyester polyol is derived from a reaction mixture comprising isosorbide, and at least one polyfunctional carboxylic acid selected from the group consisting of adipic acid, succinic acid, azelaic acid, sebacic acid, dodecandioic acid, tetradecane dioic acid, hexadecane dioic acid, octadecane dioic acid, furandicarboxylic acid, isophthalic acid, terephthalic acid, orthophthalic acid, dimerized fatty acid, trimerized fatty acid and mixtures thereof. Most preferably, the bio-based solid amorphous polyester polyol is derived from a reaction mixture comprising isosorbide, succinic acid, and a dimer fatty acid.

Anhydrohexitols are obtained by dehydration of hexitols like sorbitol (glucitol), mannitol, iditol, which are produced by reducing the carbonyl group of hexoses like glucose, mannose, idose that are typically derived from several biological feedstocks like wheat, corn, cellulose.

The double dehydration results in dianhydrohexitols. Usually, the anhydrohexitol is a dianhydrohexitol like dianhydromannitol, dianhydrosorbitol, dianhydroiditol and mixtures thereof. The dianhydrohexitol preferably is a dianhydrosorbitol, such as isosorbide, isomannide and isoidide, and more in particular is isosorbide. A few companies have specialized in the production of isosorbide, isomannide and isoidide.

Preferably, the amount of the at least one anhydrohexitol is from about 20 mol % to about 60 mol % based on the total moles of the reactants of the polyester polyol.

In addition to anhydrohexitol, the reactants of the polyester polyol may optionally comprise at least one polyol other than anhydrohexitol to react with the polyfunctional carboxylic acid.

Examples of such polyols include monoethylene glycol, 1,2-propanediol, 1,3-propanediol, 1,3-butanediol (including R-form, S-form and racemates), 1,4-butanediol, 1,4-pentanediol, 3-methylpentane-1,5-diol, neopentyl glycol (2,2-dimethyl-1,3-propanediol), 1,5-pentanediol, 1,6-hexanediol, 1,8-otaneglycol, cyclohexanedimethanol, 2-methylpropane-1,3-diol, dithyleneglycol, triethyleneglycol, tetraethyleneglycol, polyethyleneglycol, dipropyleneglycol, polypropyleneglycol, polypropyleneglycol, dibutyleneglycol and polybutyleneglycol.

Preferably, the polyol other than anhydrohexitol is fully bio-based. Examples of such polyol include but not limited to glycerol, 1,2-propanediol, 1,3-propanediol, 1,3-butanediol (including R-form, S-form and racemate), 1,4-butanediol, 1,4-pentanediol, 1,5-pentanediol, ethylene glycol, diethylene glycol and triethylene glycol. These polyols are used alone or in combination.

In one embodiment, the reactants of the polyester polyol comprise at least one polyol other than anhydrohexitol. If present, the amount of the polyol other than anhydrohexitol is from about 1 mol % to about 35 mol % based on the total moles of the reactants of the polyester polyol.

In another embodiment, the reactants of the polyester polyol only comprise anhydrohexitol as the source of polyol for the preparation of polyester

The polyester polyols are preparable by polycondensation of the anhydrohexitol and optionally at least one polyol other than anhydrohexitol with a substoichiometric amount of a polyfunctional carboxylic acid in the presence of the catalyst according to the present invention. Preferably the polyfunctional carboxylic acids have from 2 to 36 carbon atoms, such as dicarboxylic acids and/or tricarboxylic acids, or their reactive derivatives, such as carboxylic anhydride, chloride and ester.

Examples of the dicarboxylic acid include adipic acid, succinic acid, azelaic acid, sebacic acid, dodecane dioic acid, tetradecane dioic acid, hexadecane dioic acid, octadecane dioic acid, furandicarboxylic acid, isophthalic acid, terephthalic acid, orthophthalic acid, dimerized fatty acids, trimerized fatty acids and the like. These dicarboxylic acids are used alone or in combination. Examples of the carboxylic anhydride include adipic anhydride, succinic anhydride and the like. These dicarboxylic anhydrides are used alone or in combination. In one embodiment, the polyfunctional carboxylic acids are selected from succinic acid, azelaic acid, sebacic acid, dimerized fatty acid, trimerized fatty acid, and mixture thereof.

Dimerized fatty acids are the dimerization product of mono- or polyunsaturated acids and/or esters thereof. Preferred dimerized fatty acids are dimers of C10- to C36-, more preferably C12- to C24-, particularly C14- to C22-alkyl chains. Suitable dimerized fatty acids include the dimerization products of oleic acid, linoleic acid, linolenic acid, palmitoleic acid and elaidic acid. The dimerization products of the unsaturated fatty acid mixtures obtained in the hydrolysis of natural fats and oils, e.g., sunflower oil, soybean oil, olive oil, rapeseed oil, cottonseed oil and tall oil may also be used. Examples of the dimerized (dimer) fatty acids are Pripol 1019, 1013, 1017, 1006 commercially available from Croda.

According to the present invention, the amount of the at least one polyfunctional carboxylic acid is not larger than about 50 mol %, and preferably from about 40 to about 50 mol %, based on the total moles of the reactants of the polyester polyol.

The polycondensation of the anhydrohexitol and an optional polyol with the polyfunctional carboxylic acid is conducted in the presence of at least one catalyst. The catalyst is a non-metal inorganic acidic catalyst, selected from a non-metal inorganic acidic compound having phosphorus atom in oxidation state of +1, a non-metal inorganic acidic compound having phosphorus atom in oxidation state of +3, and mixture thereof. In one preferred embodiment, the at least one non-metal inorganic acidic catalyst is selected from phosphinic acid, phosphonic acid, and mixture thereof. In one more preferred embodiment, the non-metal inorganic acidic catalyst is phosphinic acid.

In a preferred embodiment of the present invention, the bio-based solid amorphous polyester polyol has a glass transition temperature (Tg) from ab 50° C., more preferably about 15 to about 45° C. In another preferred embodiment of the present invention, the bio-based solid amorphous polyester polyol has a number average molecular weight higher than about 1000 g/mol, preferably about 1700 to about 5500 g/mol, more preferably about 2000 to about 3000 g/mol.

Suitable commercially available bio-based solid amorphous polyester polyols are sold under the trade name of Dynacoll Terra 7540 (Evonik), which is partially bio-based.

According to the present invention, the bio-based liquid amorphous polyester polyol can be derived from a reaction mixture comprising at least one polyol and at least one polyacid or its derivative. Preferably, the derivative of the polyacid is the carboxylic anhydride and/or ester of the polyacid. In a preferred embodiment of the present invention, the polyol is selected from the group consisting of 1,2-propanediol, 1,3-butanediol (including R-form, S-form and racemates), 1,4-pentanediol, 1,3-propylene glycol, 1,4-butanediol, 1,6-hexane diol, diethyleneglycol, triethyleneglycol, tetraethyleneglycol, polyethyleneglycol, dipropyleneglycol, and polypropyleneglycol or mixtures thereof. In another preferred embodiment of the present invention, the polyacid is selected from the group consisting of succinic acid, azelaic acid, sebacic acid, dodecane dioic acid and dimerized fatty acids or mixtures thereof. Most preferably, the bio-based liquid crystalline polyester polyol is derived from a reaction mixture comprising azelaic acid and diethylene glycol.

In a preferred embodiment of the present invention, the bio-based liquid amorphous polyester polyol has a glass transition temperature lower than about 0° C., preferably from about −75 to about −15° C., more preferably about −65 to about −20° C. In another preferred embodiment of the present invention, the bio-based liquid amorphous polyester polyol has a number average molecular weight higher than about 1000 g/mol, preferably about 1500-about 5500 g/mol, more preferably about 2000 to about 3200 g/mol.

Suitable commercially available bio-based liquid amorphous polyester polyols are sold under the trade name of Dynacoll Terra 7640 (Evonik), Priplast 3238 (Croda), Bio-Hoopol 11034, Bio-Hoopol 13033, and Bio-Hoopol 13034 (Synthesia).

In a preferred embodiment of the present invention, the total content of the bio-based solid amorphous polyester polyol and/or the bio-based liquid amorphous polyester polyol is about 15 to about 70% by weight, preferably about 20 to about 50% by weight, based on the total weight of the adhesive composition.

In the present invention, the bio-based solid crystalline polyester polyol, the bio-based solid amorphous polyester polyol and/or the bio-based liquid amorphous polyester polyol may be partially or completely bio-based.

In an embodiment of the present invention, the high bio-content polyurethane hot melt adhesive composition according to the present invention may further comprise at least one non-bio-based solid crystalline polyester polyol and/or at least one non-bio-based liquid amorphous polyester polyol, as long as the adhesive composition contains more than 50% by weight of bio-based material, based on the total weight of the adhesive composition.

In another preferred embodiment of the present invention, the high bio-content polyurethane hot melt adhesive composition comprises at least one bio-based solid crystalline polyester polyol, at least one bio-based solid amorphous polyester polyol, and at least one bio-based liquid amorphous polyester.

c) polyisocyanate

In the present invention, the polyisocyanate can be any suitable isocyanate having at least two isocyanate groups in one molecule including, e.g., aliphatic, cycloaliphatic, araliphatic, arylalkyl, and aromatic isocyanates, and combinations thereof.

Preferable polyisocyanate can be selected from the group consisting of 4,4-diphenylmethane diisocyanate (MDI), hydrogenated MDI (H12MDI), partly hydrogenated MDI (H6MDI), xylylene diisocyanate (XDI), tetramethylxylylene diisocyanate (TMXDI), 4,4-diphenyldimethylmethane diisocyanate, dialkylenediphenylmethane diisocyanate, tetraalkylenediphenylmethane diisocyanate, 4,4-dibenzyl diisocyanate, 1,3-phenylene diisocyanate, 1,4-phenylene diisocyanate, the isomers of toluylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), tetramethoxybutane-1,4-diisocyanate, naphthalene-1,5-diisocyanate (NDI), butane-1,4-diisocyanate, hexane-1,6-diisocyanate (HDI), dicyclohexylmethane diisocyanate, 2,2,4-trimethylhexane-2,3,3-trimethylhexamethylene diisocyanate, cyclohexane-1,4-diisocyanate, ethylene diisocyanate, methylenetriphenyltriisocyanate (MIT), phthalic acid bisisocyanatoethyl ester, trimethylhexamethylene diisocyanate, 1,4-diisocyanatobutane, 1,12-diisocyanatododecane, and dimer fatty acid diisocyanate, lysine ester diisocyanate, 4,4-dicyclohexylmethane diisocyanate, 1,3-cyclohexane or 1,4-cyclohexane diisocyanate, and combinations thereof. The most preferred polyisocyanate is 4,4-diphenylmethane diisocyanate (MDI) and its isomers, chain-extended MDI, and combinations thereof.

Useful commercially available polyisocyanates include DESMODUR 44 C FUSED, Desmodur 0118 I and Desmodur 44M from Covestro, Vannate MDI 100F from Wanhua Chemicals, Supresec 1809 from HUNTSMAN.

In a preferred embodiment of the present invention, the polyisocyanate is present in an amount of about 10 to about 25% by weight, preferably about 15 to about 22% by weight, based on the total weight of the adhesive composition.

In an embodiment of the present invention, the high bio-content polyurethane hot melt adhesive composition may further comprise at least one polyether polyol and/or at least one (meth)acrylic resin.

### Polyether Polyol

The polyether polyols used in the present invention are well known to those skilled in the art. These polyether polyols are obtained by copolymerizing at least one compound of ethylene oxide, propylene oxide, butylene oxide, tetrahydrofuran, etc. with at least one compound having at least two active hydrogen atoms on average in one molecule such as the polyhydric alcohols list above which include ethylene glycol, propylene glycol, dipropylene glycol, glycerol, and combinations thereof. Other suitable polyhydric compounds include sucrose, ethylenediamine, propylenediamine, triethanolamine, 1,2-propanedithiol, and combinations thereof.

Preferred polyether polyols can be selected from polytetramethylene ether glycol, poly(oxypropylene) glycol, polyethylene oxide, polybuthylene oxide, and ethylene oxide endcapped versions of any of the foregoing, as well as the combinations thereof. The most preferred polyether polyols are polytetramethylene ether glycol, poly(oxypropylene) glycol, ethylene oxide endcapped poly(oxypropylene)glycol, and combinations thereof.

In the present invention, the polyether polyol may be bio-based or non-bio-based.

In preferred embodiments, the polyether polyol has a number average molecular weight (Mn) of from about 200 to about 8000 g/mol, preferably from about 400 to about 4000 g/mol, and more preferably from about 400 to about 2000 g/mol.

Examples of commercially available polyether polyols useful in the present invention include, but not limited to, Voranol 2104, 2110, 2120 and 2140 from Dow Chemical Company, and Velvetol H2000 and H1000 from Weylchem, which are bio-based.

With particular preference, the polyether polyol is present in an amount of from about 2% to about 30% by weight, and more preferably from about 5% to about 15% by weight, based on the total weight of the adhesive composition.

### (Meth)Acrylic Resin

The (meth)acrylic resin used in the present invention may be linear or branched, may consist of copolymerized alkyl functional (meth)acrylic monomers, acid functional (meth)acrylic monomers, tertiary amine functional (meth)acrylic monomers, and may contain other functional groups that do not react rapidly with isocyanate functional groups. Branching in the (meth)acrylic resin can be induced by copolymerizing a polyfunctional comonomer and/or using a polyfunctional chain transfer agent and/or a polyfunctional initiator.

Suitable comonomers used to form (meth)acrylic resin of the present invention include the C1 to C12 esters of methacrylic and acrylic acids including, but not limited to methyl methacrylate, ethyl methacrylate, n-propyl, iso-propyl methacrylate, n-butyl methacrylate, isobutyl methacrylate, n-hexyl methacrylate, n-octyl methacrylate 2-ethylhexyl methacrylate, dodecyl (lauryl) methacrylate or the corresponding acrylates. Mixtures of compatible (meth)acrylate monomers may also be used. Methacrylic and acrylic comonomers based on esters of methacrylic and acrylic acid with poly(ethylene glycol) and/or poly(propylene glycol and/or glycol ethers may also be used. Other additional vinyl comonomers that may be used include the vinyl esters (e.g. vinyl acetate and vinyl propionate); vinyl ethers; esters of crotonic acid, maleic acid, fumaric acid and itaconic acid; styrene; alkyl styrenes; acrylonitrile; butadiene; etc. as well as comonomers thereof. The particular monomers selected will depend, in large part, upon the end use for which the adhesives are intended.

Suitable acid functional comonomers used to form (meth)acrylic resin of the present invention include, but are not limited to, methacrylic acid and acrylic acid.

Suitable hydroxyl functionalized comonomers used to form (meth)acrylic resin of the present invention that can be incorporated include, but are not limited to, 2-hydroxyethylmethacrylate, 2-hydroxylpropyl methacrylate and 2-hydroxybutyl methacrylate or the corresponding acrylates.

Suitable amine functionalized comonomers used to form (meth)acrylic resin of the present invention include, but are not limited to, dimethylaminoethyl methacrylate, diethylaminoethyl methacrylate or the corresponding acrylates.

The (meth)acrylic resin can be prepared by free-radical polymerization, and molecular weight (Mn) is controlled by using a chain transfer agent, e chain transfer based on transition metal complexes. Branched (meth)acrylic resins are made by copolymerizing a multifunctional monomer and/or using a multifunctional chain transfer agent and/or using a multifunctional initiator.

In preferred embodiments, the (meth)acrylic resin has a number average molecular weight (Mn) of from about 5,000 to about 100,000 g/mol, preferably from about 5,000 to about 80,000 g/mol, and more preferably from about 8,000 to about 50,000 g/mol.

Examples of commercially available (meth)acrylic resin useful in the present invention include, but not limited to, Dianal MB-2595 and Elvacite 2013, both of which are available from Mitsui Chemicals, Inc.

According to the present invention, the content of the (meth)acrylic resin may be less than about 20% by weight, based on the total weight of the adhesive composition.

### Catalyst

The catalyst used in the present invention is used to facilitate the reaction between the polyester polys with the polyisocyanate.

Suitable catalysts include, for example, strongly basic amides, such as 2,3-dimethyl-3,4,5,6-tetrahydropyrimidine, tris-(dialkylaminoalkyl)-s-hexahydrotriazines, for example tris-(N,N-dimethylaminopropyl)-s-hexahydrotriazine or the usual tertiary amines, for example triethylamine, tributylamine, dimethylbenzylamine, N-ethyl-, N-methyl-, N-cyclo-hexylmorpholine, dimethylcyclohexylamine, dimorpholinodiethylether, 2-(dimethylaminoethoxy)-ethanol, 1,4diazabicyclo[2,2,2]octane, 1-azabicyclo[3,3,0]octane, N,N,N′,N′-tetramethyl ethylenediamine, N,N,N′,N′-tetramethyl butanediamine, N,N,N′,N′-tetramethyl hexane-1,6-diamine, pentamethyl diethylenetriamine, tetramethyl diaminoethylether, bis-(dimethylaminopropyl)-urea, N,N′-dimethylpiperazine, 1,2-dimethylimidazole, di-(4-N,N-dimethylaminocyclohexyl)-methane and the like and organometallic compounds, such as titanic acid esters, iron compounds, for example iron(III) acetyl acetonate, tin compounds, for example tin(II) salts of organic carboxylic acids, for example tin(II) diacetate, the tin(II) salt of 2-ethylhexanoic acid (tin(II) octoate), tin(II) dilaurate or the dialkyltin(IV) salts of organic carboxylic acids, for example dibutyltin(IV) diacetate, dibutyltin(IV) dilaurate, dibutyltin(IV) maleate or dioctyltin(IV) diacetate or the like, and dibutyltin(IV) dimercaptide or mixtures of two or more of the catalysts mentioned and synergistic combinations of strongly basic amines and organometallic compounds.

The catalyst is present in the adhesive composition in an amount of from about 0.05% to about 1% by weight, and preferably from about 0.05% to about 0.5% by weight, based on the total weight of the adhesive composition.

### Additives

Optionally, the high bio-content polyurethane hot melt adhesive composition may comprise at least one additive. Such additive can be those commonly used in the art, such as leveling agent, adhesion promoters, antioxidants, film-forming agents etc.

Examples of leveling agent include an acrylate copolymer, which may be commercially available from BASF under the trade name of Efka FL 3740.

Examples of adhesion promoter include gamma-mercaptopropyltrimethoxysilane, which may be commercially available from Momentive Performance Materials under the trade name of Silquest A 189.

Examples of antioxidant include phenolic types such as BHT (butylated hydroxytoluene), octadecyl-3,5-bis(1,1-dimethyl)-4-hydroxybenzene-propanoate, Pentaerythritol tetrakis(3-(3,5-di-tert-butyl-4-hydroxyphenyl)propionate), and pyrogallol; phosphites such as triphenyl phosphite, tris(nonylphenyl)phosphite; or thioesters such as dilauryl thiodipropionate, and combinations thereof. In particular, the antioxidant may be Pentaerythritol tetrakis(3-(3,5-di-tert-butyl-4-hydroxyphenyl)propionate), which may be commercially available from Everspring company under the trade name of Evernox 10

Examples of film-forming agent include 1-(P-toluenesulfonyl)imidazole (PTSI), which may be commercially available from VanDeMark company.

If present, the additive(s) may be present in an amount of from about 0.01% to about 2% by weight, and preferably from about 0.05% to about 1% by weight, based on the total weight of the adhesive composition.

As compared with the polyurethane hot melt adhesive compositions in the prior art, the high bio-content polyurethane hot melt adhesive composition according to the present invention contains more than 50% by weight of bio-based material, based on the total weight of the adhesive composition, at the same time exhibit excellent bonding strength and good impact resistance.

### Preparation Method of the High Bio-Content Polyl

The high bio-content polyurethane hot melt adhesive composition according to the present invention may be prepared in the method conventionally used in the art, as long as all the components therein can be uniformly mixed. In particular, the high bio-content polyurethane hot melt adhesive composition according to the present invention may be prepared as follows:
(i) adding all the polyester polyols and optional (meth)acrylic resins, and melting and mixing them until homogeneous and free of moisture;
(ii) adding at least one polyisocyanate, and mixing the mixture obtained under vacuum at 80° C. to 120° C. until the reaction is completed; and
(iii) adding catalyst and optional additives and stirring the mixture at 80° C. to 120° C. until homogeneous.

A apparatus for preparing the high bio-content polyurethane hot melt adhesive composition according to the present invention can be any conventional apparatus in the art; and its examples include an automated mortar, a Henschel mixer, a three-roll mill, a ball mill, a planetary mixer, a bead mill, and the like which are equipped with a stirrer and a heater.

### Electronic Device

The present invention further provides an electronic device, preferably a handheld device assembly, obtained with the high bio-content polyurethane hot melt adhesive composition according to the present invention.

The high bio-content polyurethane hot melt adhesive composition of the present invention can be applied to a substrate using any suitable application method including, e.g., automatic fine line dispensing, jet dispensing, slot die coating, roll coating, gravure coating, transfer coating, pattern coating, screen printing, spray coating, filament coating, by extrusion, air knife, trailing blade, brushing, dipping, doctor blade, offset gravure coating, rotogravure coating, and combinations thereof. The high bio-content polyurethane hot melt adhesive composition can be applied as a continuous or discontinuous coating, in a single or multiple layers and combinations thereof.

### Use

Lastly, the present invention provides a use of the high bio-content polyurethane hot melt adhesive composition according to the present invention in manufacturing an electronic device, preferably a handheld device assembly.

Suitable electronic devices includes, but not limited to, e.g., wearable electronic devices (e.g., wrist watches and eyeglasses), handheld electronic c cellular smartphones), cameras, tablets, electronic readers, monitors (e.g., monitors used in hospitals, and by healthcare workers, athletes and individuals), watches, calculators, mice, touch pads, and joy sticks), computers (e.g., desk top and lap top computers), computer monitors, televisions, media players, or other electronic components.

The invention will be illustrated in more detail by way of the following examples which are not to be understood as limiting the concept of the invention.

### EXAMPLES

All parts and percentages are based on weight unless otherwise stated.

### Raw Materials

The following materials were used in the examples.

### Polyols:

### Polyether Polyol:

Voranol 2110, a commercial product from Dow Plastics, Number average molecular weight 1000 g/mol.

Velvetol H2000, 100% bio based polyol, a commercial product from WeylChem, Number average molecular weight 2000 g/mol.

Velvetol H1000, 100% bio based polyol, a commercial product from WeylChem, Number average molecular weight 1000 g/mol.

### Polyester Polyol:

### Solid Crystalline Polyester Polyol:

Dynacoll 7380, a commercial product from Evonik Degussa, Number average molecular weight 3500 g/mol.

Dynacoll 7360, a commercial product from Evonik Degussa, Number average molecular weight 3500 g/mol.

Dynacoll 7340, a commercial product from Evonik Degussa, Number average molecular weight 3500 g/mol.

Dynacoll Terra 7750, 100% bio based polyol, a commercial product from Evonik Degussa, Number average molecular weight 3500 g/mol.

PES 2, 100% bio based solid, crystalline, saturated copolyester having an acid number of no larger than 2 mg KOH/g, and a hydroxyl number of 25 to 35 mg KOH/g.

Bio-Hoopol 11003, 100% bio based polyol, a commercial product from Synthesia, Number average molecular weight 2000 g/mol.

### Solid Amorphous Polyester Polyol:

Dynacoll 7111, a commercial product from Evonik Degussa, Number average molecular weight 3500 g/mol and glass transition temperature of 20° C.

PES 1, a 100% bio based solid, solid amorphous, saturated copolyester having an acid number of no larger than 5 mg KOH/g, and a hydroxyl number of 55 to 65 mg KOH/g.

Dynacoll Terra 7540, 35% bio based polyol, a commercial product from Evonik Degussa, Number average molecular weight 3500 g/mol.

### Liquid Amorphous Polyester Polyol:

Stepanpol PDP 70, a commercial product from Stepan, Number average molecular weight 1600 g/mol.

Priplast 3238, 100% bio based polyol, a commercial product from Croda, Number average molecular weight 2000 g/mol.

PES 3, a 100% bio based liquid amorphous, saturated copolyester having an acid number of no larger than 2 mg KOH/g, and a hydroxyl number of 55 to 65 mg KOH/g.

### Acrylate Polymer:

Dianal MB-2595, a solid methacrylate copolymer bead resin with a number average molecular weight of 8,000 g/mol (Tg: about 59° C.), commercially available from Mitsui Chemicals, Inc.

Elvacite 2013, a solid methacrylate copolymer bead resin with a number average molecular weight of 34,000 g/mol (Tg: about 80° C.), commercially available from Mitsui Chemicals, Inc.

### Catalyst:

2,2′-dimorpholinodiethyl ether (DMDEE)

### Polyisocyanate:

4,4′-MDI: a commercial product under the trade name of Desmodur 44C from Covestro.

### Adhesive Promoter:

Silquest A 189, gamma-mercaptopropyltrimethoxysilane, a commercial product from Momentive Performance Materials.

### Additives:

Efka FL 3740, Acrylate copolymer, a commercial product form BASF.

Evernox 10, Pentaerythritol tetrakis(3-(3,5-di-tert-butyl-4-hydroxyphenyl)propionate), a commercial product from Everspring company

PTSI, Toluenesulfonyl isocyanate, a commercial product from VanDeMark company.

### Preparation of Polyester Polyols

The following materials were used in the preparation of PES 1 to PES 3.

Sebacic acid was obtained from Sigma Aldrich.

Succinic acid was obtained from Sigma Aldrich.

Isosorbide was obtained from Roquette under the trade name of Polysorb PA.

Azelaic acid was obtained from Croda.

Diethylene glycol was obtained from Sigma Aldrich.

Ethylene glycol was obtained from Sigma Aldrich.

Dimer fatty acid was obtained from Croda under the trade name of Pripol.

Phosphinic acid was obtained from Sigma Aldrich.

PES 1, PES 2 and PES 3 were prepared according to the formulations in Table 1.

A 1 or 5 liter, 4 neck flask equipped with a nitrogen sparge tube, thermocouple, overhead stirrer and distillation arm was charged with polyacid(s) and polyol(s). The mixture was heated stepwise to maximum 220° C. under nitrogen flow. The complete reaction can take approximately 20 h to 40 h depending on reaction compositions (monomers and catalyst). A catalyst was optionally added directly from the beginning or during the course of the polycondensation reaction. Subsequently, the pressure of the system was reduced stepwise to 10-300 mbar to achieve total conversion. Once the acid value reached a value of 3 mg KOH/g or less, the reaction was cooled. The polyester polyol was characterized by its acid value in mg KOH/g, hydroxyl value in mg KOH/g, viscosity in Pa-s at a specific temperature as well as Mn in g/mol according to the GPC method. DSC measurements were performed in order to determine the Tg and melting point Tm in ° C. of the final polyester polyols.

TABLE 1
Reactants and properties of PES 1 to PES 3

| | PES 1 | PES 2 | PES 3 |
|---|---|---|---|
| Reactants | | | |
| Sebacic acid | — | 217.25 | — |
| (weight in grams) | | | |
| Succinic acid | 86.58 | — | — |
| (weight in grams) | | | |
| Azelaic acid | — | — | 171.06 |
| (weight in grams) | | | |
| Dimer fatty acid | 83.25 | — | — |
| (weight in grams) | | | |
| Ethylene glycol | — | 71.35 | — |
| (weight in grams) | | | |
| Diethylene glycol | — | — | 111.60 |
| (weight in grams) | | | |
| Isosorbide | 152.22 | — | — |
| (weight in grams) | | | |
| Phosphinic acid | 0.61 | — | — |
| (weight in grams) | | | |
| Properties | | | |
| Acid number | 1.6 | 1.4 | 0.3 |
| (mgKOH/g) | | | |
| OH number | 61 | 32 | 64 |
| (mgKOH/g) | | | |
| Viscosity@80° C. | 363 | 0.88 | 0.84 |
| (Pa · s) | | | |
| Molecular weight | 2644 | 3507 | 1753 |
| (Mn, g/mol) | | | |
| Tg (° C.) | 21 | — | −62 |
| Tm (° C.) | — | 77 | — |
| Physical state | Amorphous | Crystalline | Amorphous |
| | Solid | solid | liquid |
| Color | Pale yellow | White to | Yellowish |
| | to | yellowish | |
| | yellowish | | |

### Preparation of Polyurethane Hot Melt Adhesive Compositions

Polyurethane hot melt adhesive compositions of Comparative Examples 1-5 (CE1-5) and Inventive Examples 1-7 (EX1-7) comprising the components as shown in the following tables were prepared as follows. All the polyols and acrylate polymers (if any) were added to melt and mix under vacuum until homogeneous and free of moisture. Then 4,4-MDI was added and polymerization allowed to proceed with mixing under vacuum at 100° C. until reaction is complete after one hour. Finally, catalyst, adhesion promoter and additives were added, and the resulting mixture was stirred at 100° C. for 10 minutes. The resulting reactive hot melt adhesive was then placed into a container under a dry nitrogen headspace to prevent exposure to moisture.

### Testing Methods

### Viscosity:

Brookfield Digital Viscometer RVT with a thermoset heating unit, using spindle 27, at 110° C., at 10 rpm, according to EN ISO 2555.

### Fixture Strength was Measured According to Cross Tensile Strength:

The values of bonding strength of the assembled parts (stainless steel to plastics made of polycarbonate) at room temperature were measured at 6 min, 40 min and 2 hours after curing according to the following method:

Firstly, polycarbonate substrate and stainless steel substrate having a width of 25.4 mm and a length of 101.6 mm were prepared. They were cleaned with ethanol before use and allowed to dry. Then, two 127 um gap spacers were placed on the stainless-steel lap-shear. Two lines (25.4 mm length) of adhesive were applied parallel to the centre of the prepared surface of the stainless steel lap-shear specimen. The distance between each bead adhesive and the edge of lap-shear was 8 mm. After dispensing adhesive, the second lap-shear specimen was assembled perpendicularly, making sure adhesive lines were vertical to the second (top) lap-shear. A 2 KG weight block was placed on top of the lap-shear specimens for 15 seconds. The samples were cured for the required time hours at 23° C., 50% relative humidity. Tensile cross strength and fixture strength are measured on a Zwick at a crosshead speed of 2.0 mm/min. Record the load at failure and the failure mode (adhesive or cohesive failure).

### Final Bonding Strength was Measured According to Lap Shear Strength:

The values of bonding strength of the assembled parts (stainless steel to plastics made of polycarbonate) after measured 24 hours after final curing according to the following method:

Firstly, two polycarbonate substrates having a width of 25.4 mm and a length of 101.6 mm were prepared. They were cleaned with isopropanol before use and allowed to dry. Then, two 127 μm gap spacers were placed on the stainless-steel lap-shear. One lines (25.4 mm length) of adhesive were applied parallel to the centre of the prepared surface of the polycarbonate lap-shear specimen. The distance between the bead adhesive and the edge of lap-shear was 6.3 mm. After dispensing adhesive, the second lap-shear specimen was assembled horizontally, making sure the adhesive line was aligned with the second (top) lap-shear. A 2 KG weight block was placed on top of the lap-shear specimens for 15 seconds. The samples were cured for the required time hours at 23° C., 50% relative humidity. Tensile cross strength and fixture strength are measured on a Zwick at a crosshead speed of 10.0 mm/min. Record the load at failure and the failure mode (adhesive or cohesive failure).

### Dupont Impact Energy Test:

The impact resistance of the cured adhesive composition was evaluated by Du Pont impact energy using a lap-shear assembly.

Firstly, a polycarbonate substrate having a width of 25.4 mm and a length of 101.6 mm, a polycarbonate substrate which is in a size of 25.4 mm width and 101.6 mm length with a hole having a diameter of 10 mm in the centre and a polyethylene terephthalate (PET) film with a hole having a diameter of 12 mm in the centre and 0.12 mm thickness were prepared. The PET film has a tape on one surface for bonding to the polycarbonate substrate in order to control the adhesive layer's width and thickness. The substrates were cleaned with isopropanol and idled at ambient conditions for several minutes to make sure the surface was completely dry. The PET film was bonded to the polycarbonate substrate, to make sure the position of the centric hole in PET film faced with the position of the centric hole in the polycarbonate substrate. The diameter of the polycarbonate substrate was 2 mm larger than the PET film, which forms a circular ring area in a width of 1 mm.

Then, the adhesive composition was dispensed within the said circular ring area on the polycarbonate substrate, and then the other polycarbonate substrate was placed crosswise to cover the centric hole of the polycarbonate substrate, and the overlapping area, i.e., the circular ring area was to be formed an adhesive layer in a width of 1 mm and a thickness of 0.12 mm sandwiched there between. The samples were cured for the required time hours at 23° C., 50% relative humidity for 72 hours.

### Sample Testing:

A 50 g weight was dropped on the specimen from a height of 2 cm as a starting point. If the polycarbonate substrate were not peeled from the polycarbonate substrate for 3 times, then the weight was raised to a height of 2 cm higher than the previous height to drop. If the polycarbonate substrate was not peeled from the polycarbonate substrate using a 50 g weight at the height of 50 cm, then a 60 g weight was used to conduct the test. The Du Pont impact energy was calculated using the following equation:

$$E = m * g * h * 0.01 ,$$

wherein E is impact energy (mJ), m is weight (g) when substrates were peeled from each other, h is the height (cm) of the weight loosed from when substrates were peeled from each other, g is 9.8 m/s².

TABLE 2
Components and properties of the polyurethane hot melt adhesive compositions

| | | | CE. 1 | CE. 2 | CE. 3 | EX. 1 |
|---|---|---|---|---|---|---|
| | | | (in wt %) | (in wt %) | (in wt %) | (in wt %) |
| Components | | | | | | |
| Polyether polyol | Voranol 2110 | | 7 | 7 | 7 | 7 |
| | Velvetol H2000 | | | | | |
| | Velvetol H1000 | | | | | |
| Solid Crystalline PES | Dynacoll 7380 | | | | | |
| | Dynacoll 7360 | | 20.2 | | | |
| | Dynacoll 7340 | | | | | |
| | Dynacoll Terra 7750 | | | | | |
| | PES 2 | | | 20.2 | 20.2 | 20.2 |
| | Bio-Hoopol 11003 | | | | | |
| Solid amorphous PES | Dynacoll 7111 | | | | 20 | |
| | PES 1 | | 20 | 20 | | 20 |
| | Dynacoll Terra 7540 | | | | | |
| Liquid amorphous PES | Stepanpol PDP 70 | | | 25 | 25 | |
| | Priplast 3238 | | | | | |
| | PES 3 | | 25 | | | 25 |
| Acrylate resin | Dianal MB-2595 | | 8 | 8 | 8 | 8 |
| | Elvacite 2013 | | | | | |
| Isocyanate | MDI | | 18.77 | 18.77 | 18.77 | 18.77 |
| Catalyst | Dimorpholinodiethyl | | 0.2 | 0.2 | 0.2 | 0.2 |
| | ether | | | | | |
| Adhesion promoter | Silquest A 189 | | 0.5 | 0.5 | 0.5 | 0.5 |
| Additives | Efka FL 3740 | | 0.2 | 0.2 | 0.2 | 0.2 |
| | Evernox 10 | | 0.1 | 0.1 | 0.1 | 0.1 |
| | PTSI | | 0.03 | 0.03 | 0.03 | 0.03 |
| | Bio % | | 45 | 40.2 | 20.2 | 65.2 |
| | Total | | 100 | 100 | 100 | 100 |
| Properties | | | | | | |
| Dupont Impact Energy | | | 300 | 280 | 255 | 375 |
| (mJ) | | | | | | |
| Cross tensile strength | 6 | min | 0.18 | 0.1 | 0.08 | 0.3 |
| (PC/SUS) | 40 | min | 1.18 | 1.1 | 0.95 | 1.48 |
| | 2 | H | 1.6 | 1.56 | 1.44 | 1.8 |
| Lap shear strength | 24 | H | 14.3 | 10.4 | 9.5 | 22.4 |
| (PC/PC) | | | | | | |

From Table 2, it can be seen that compared with the polyurethane hot melt adhesive compositions in the prior art, which do not comprise bio-based solid crystalline polyester polyol (CE), bio-based liquid amorphous polyester polyol (CE2), or both bio-based solid amorphous polyester polyol and bio-based liquid amorphous polyester polyol (CE3), the polyurethane hot melt adhesive composition according to the present invention (EX1) had a higher bio-content, and exhibited better dupont impact energy, cross tensile strength (PC/SUS) and lap shear strength (PC/PC).

TABLE 3
Components and properties of the polyurethane hot melt adhesive compositions

| | | | CE. 4 | CE. 5 | EX. 2 |
|---|---|---|---|---|---|
| | | | (in wt %) | (in wt %) | (in wt %) |
| Components | | | | | |
| Polyether polyol | Voranol 2110 | | 8 | 8 | 8 |
| | Velvetol H2000 | | | | |
| | Velvetol H1000 | | | | |
| Crystalline PES | Dynacoll 7380 | | | | |
| | Dynacoll 7360 | | 22.7 | | |
| | Dynacoll 7340 | | 7 | 7 | 7 |
| | Dynacoll Terra 7750 | | | | |
| | PES 2 | | | 22.7 | 22.7 |
| | Bio-Hoopol 11003 | | | | |
| Solid amorphous PES | Dynacoll 7111 | | | | |
| | PES 1 | | | | |
| | Dynacoll Terra 7540 | | | | |
| Liquid amorphous PES | Stepanpol PDP 70 | | | 29.27 | |
| | Priplast 3238 | | | | |
| | PES 3 | | 29.27 | | 29.27 |
| Acrylate resin | Dianal MB-2595 | | 8 | 8 | 8 |
| | Elvacite 2013 | | 8 | 8 | 8 |
| Isocyanate | MDI | | 16 | 16 | 16 |
| Catalyst | Dimorpholinodiethyl | | 0.2 | 0.2 | 0.2 |
| | ether | | | | |
| Adhesion promoter | Silquest A 189 | | 0.5 | 0.5 | 0.5 |
| Additives | Efka FL 3740 | | 0.2 | 0.2 | 0.2 |
| | Evernox 10 | | 0.1 | 0.1 | 0.1 |
| | PTSI | | 0.03 | 0.03 | 0.03 |
| | Bio % | | 29.27 | 22.7 | 51.97 |
| | Total | | 100 | 100 | 100 |
| Properties | | | | | |
| Dupont Impact Energy | | | 320 | 293 | 400 |
| (mJ) | | | | | |
| Cross tensile strength | 6 | min | 0.15 | 0.2 | 0.7 |
| (PC/SUS) | 40 | min | 1.2 | 1.2 | 1.6 |
| | 2 | H | 1.35 | 1.4 | 2.35 |
| Lap shear strength | 24 | H | 15.3 | 10.8 | 19 |
| (PC/PC) | | | | | |

As can be seen from Table 3, compared with the polyurethane hot melt adhesive compositions in the prior art, which do not comprise bio-based solid crystalline polyester polyol (CE4), or bio-based liquid amorphous polyester polyol (CE5), the polyurethane hot melt adhesive composition according to the present invention (EX2) had a higher bio-content, and exhibited better dupont impact energy, cross tensile strength (PC/SUS) and lap shear strength (PC/PC).

TABLE 4
Components and properties of the polyurethane hot melt adhesive compositions

| | | | EX. 3 | EX. 4 | EX. 5 | EX. 6 | EX. 7 |
|---|---|---|---|---|---|---|---|
| Components | | | (in wt %) | (in wt %) | (in wt %) | (in wt %) | (in wt %) |
| Polyether polyol | Voranol 2110 | | | | | | |
| | Velvetol H2000 | | 7 | 7 | 7 | | |
| | Velvetol H1000 | | 7 | 7 | 7 | | 8 |
| Crystalline PES | Dynacoll 7380 | | 3 | 3 | 5 | | 5.5 |
| | Dynacoll 7360 | | 12 | 12 | 14 | | |
| | Dynacoll 7340 | | | | | | |
| | Dynacoll Terra 7750 | | 10 | | | 15.3 | 6 |
| | PES 2 | | 9 | 9.5 | 10 | 18.6 | 8 |
| | Bio-Hoopol 11003 | | | 9.9 | 10.4 | | 14.7 |
| Solid amorphous PES | Dynacoll 7111 | | | | | | |
| | PES 1 | | 16 | 15.2 | 16 | | |
| | Dynacoll Terra 7540 | | | | | 16.5 | |
| Liquid amorphous PES | Stepanpol PDP 70 | | | | | 8.9 | |
| | Priplast 3238 | | | | | 12 | |
| | PES 3 | | 15.7 | 15.2 | 10 | | 17.8 |
| Acrylate resin | Dianal MB-2595 | | | | | 10 | 8 |
| | Elvacite 2013 | | | | | | 8 |
| Isocyanate | MDI | | 19.27 | 20.17 | 19.57 | 17.67 | 17.97 |
| Catalyst | Dimorpholinodiethyl | | 0.2 | 0.2 | 0.2 | 0.2 | 0.2 |
| | ether | | | | | | |
| Adhesion promoter | Silquest A 189 | | 0.5 | 0.5 | 0.5 | 0.5 | 0.5 |
| Additives | Efka FL 3740 | | 0.2 | 0.2 | 0.2 | 0.2 | 0.2 |
| | Evernox 10 | | 0.1 | 0.1 | 0.1 | 0.1 | 0.1 |
| | PTSI | | 0.03 | 0.03 | 0.03 | 0.03 | 0.03 |
| | Bio % | | 64.7 | 63.8 | 60.4 | 51.68 | 59.5 |
| | Total | | 100 | 100 | 100 | 100 | 100 |
| Properties | | | | | | | |
| Dupont Impact Energy | | | 433 | 412 | 344 | 380 | 418 |
| (mJ) | | | | | | | |
| Cross tensile strength | 6 | min | 0.44 | 0.7 | 0.6 | 0.5 | 0.45 |
| (PC/SUS) | 40 | min | 1.35 | 1.5 | 1.64 | 1.58 | 1.3 |
| | 2 | H | 1.7 | 1.78 | 2.5 | 2.85 | 2.52 |
| Lap shear strength | 24 | H | 20.46 | 19 | 29.36 | 21.4 | 18.5 |

(PC/PC)

As can be seen from Table 4, all of the polyurethane hot melt adhesive composition according to the present invention comprising bio-based polyether polyol, that comprising petro-based crystalline polyester polyols, that comprising no (meth)acrylic resin had high bio-contents, and exhibited excellent dupont impact energy, cross tensile strength (PC/SUS) and lap shear strength (PC/PC), as long as they fall within the protection scope of the present invention.

Although some preferred embodiments have been described, many modifications and variations may be made thereto in light of the above teachings. It is therefore to be understood that the invention may be practiced otherwise than as specifically described without departing from the scope of the appended claims.

1. A high bio-content polyurethane hot melt adhesive composition comprising:
at least one polyurethane prepolymer obtained from the reaction of
a) at least one bio-based solid crystalline polyester polyol;
b) at least one bio-based solid amorphous polyester polyol, and/or at least one bio-based liquid amorphous polyester; and
c) at least one polyisocyanate;
in a presence of a catalyst,
wherein the adhesive composition contains more than 50% by weight of bio-based material, based on the total weight of the adhesive composition.

2. The high bio-content polyurethane hot melt adhesive composition according to claim 1, wherein the bio-based solid crystalline polyester polyol is derived from a reaction mixture comprising at least one polyacid or its derivative and at least one polyol.

3. The high bio-content polyurethane hot melt adhesive composition according to claim 1, wherein the bio-based solid crystalline polyester polyol has a melting point of from about 10 to about 110° C.; and/or has a number average molecular weight larger than about 1000 g/mol.

4. The high bio-content polyurethane hot melt adhesive composition according to claim 1, wherein the bio-based solid amorphous polyester polyol is derived from a reaction mixture comprising at least one polyol and at least one polyacid; wherein the bio-based solid amorphous polyester polyol is derived from a reaction mixture comprising at least one anhydrohexitol and at least one polyfunctional carboxylic acid.

5. The high bio-content polyurethane hot melt adhesive composition according to claim 1, wherein the bio-based solid amorphous polyester polyol has a glass transition temperature (Tg) from about 5 to about 80° C.; and/or has a number average molecular weight larger than about 1000 g/mol.

6. The high bio-content polyurethane hot melt adhesive composition according to claim 1, wherein the bio-based liquid amorphous polyester polyol is derived from a reaction mixture comprising at least one polyol and at least one polyacid or its derivative wherein the derivative is the carboxylic anhydride and/or ester of the polyacid; and/or the polyacid is selected from the group consisting of succinic acid, azelaic acid, sebacic acid, dodecane dioic acid and dimerized fatty acids or mixtures thereof.

7. The high bio-content polyurethane hot melt adhesive composition according to claim 1, wherein the bio-based liquid amorphous polyester polyol has a glass transition temperature lower than about 0° C., and/or has a number average molecular weight larger than about 1000 g/mol.

8. The high bio-content polyurethane hot melt adhesive composition according to claim 1, further comprising at least one polyether polyol and/or at least one (meth)acrylic resin.

9. The high bio-content polyurethane hot melt adhesive composition according to claim 1, wherein the bio-based solid crystalline polyester polyol, the bio-based solid amorphous polyester polyol and/or the bio-based liquid amorphous polyester polyol are partially or completely bio-based; and/or the composition further comprises at least one non-bio-based solid crystalline polyester polyol and/or at least one non-bio-based liquid amorphous polyester polyol.

10. The high bio-content polyurethane hot melt adhesive composition according to claim 1, wherein the bio-based solid crystalline polyester polyol is present in an amount of about 10 to about 40% by weight, based on the total weight of the adhesive composition.

11. The high bio-content polyurethane hot melt adhesive composition according to claim 1, wherein the total content of the bio-based solid amorphous polyester polyol and/or the bio-based liquid amorphous polyester polyol is about 15 to about 70% by weight, based on the total weight of the adhesive composition.

12. The high bio-content polyurethane hot melt adhesive composition according to claim 1, wherein the polyisocyanate is selected from the group consisting of 4,4-diphenylmethane diisocyanate (MDI), hydrogenated MDI (H12MDI), partly hydrogenated MDI (H6MDI), xylylene diisocyanate (XDI), tetramethylxylylene diisocyanate (TMXDI), 4,4-diphenyldimethylmethane diisocyanate, dialkylenediphenylmethane diisocyanate, tetraalkylenediphenylmethane diisocyanate, 4,4-dibenzyl diisocyanate, 1,3-phenylene diisocyanate, 1,4-phenylene diisocyanate, the isomers of toluylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), tetramethoxybutane-1,4-diisocyanate, naphthalene-1,5-diisocyanate (NDI), butane-1,4-diisocyanate, hexane-1,6-diisocyanate (HDI), dicyclohexylmethane diisocyanate, 2,2,4-trimethylhexane-2,3,3-trimethylhexamethylene diisocyanate, cyclohexane-1,4-diisocyanate, ethylene diisocyanate, methylenetriphenyltriisocyanate (MIT), phthalic acid bisisocyanatoethyl ester, trimethylhexamethylene diisocyanate, 1,4-diisocyanatobutane, 1,12-diisocyanatododecane, and dimer fatty acid diisocyanate, lysine ester diisocyanate, 4,4-dicyclohexylmethane diisocyanate, 1,3-cyclohexane or 1,4-cyclohexane diisocyanate, and combinations thereof.

13. The high bio-content polyurethane hot melt adhesive composition according to claim 1, wherein the catalyst is selected from the group consisting of strongly basic amides, triethylamine, tributylamine, dimethylbenzylamine, N-ethyl-, N-methyl-, N-cyclo-hexylmorpholine, dimethylcyclohexylamine, dimorpholinodiethylether, 2-(dimethylaminoethoxy)-ethanol, 1,4-diazabicyclo[2,2,2]octane, 1-azabicyclo[3,3,0]octane, N,N,N′,N′-tetramethyl ethylenediamine, N,N,N′,N′-tetramethyl butanediamine, N,N,N′,N′-tetramethyl hexane-1,6-diamine, pentamethyl diethylenetriamine, tetramethyl diaminoethylether, bis-(dimethylaminopropyl)-urea, N,N′-dimethylpiperazine, 1,2-dimethylimidazole, di-(4-N,N-dimethylaminocyclohexyl)-methane, organometallic compounds, and combinations thereof.

14. The high bio-content polyurethane hot melt adhesive composition according to claim 1, wherein the polyisocyanate is present in an amount of about 10 to about 25% by weight, based on the total weight of the adhesive composition.

15. The high bio-content polyurethane hot melt adhesive composition according to claim 1, wherein the catalyst is present in an amount of about 0.05 to about 1% by weight, based on the total weight of the adhesive composition.

16. A method for preparing a high bio-content polyurethane hot melt adhesive composition according to claim 1, comprising the steps:
(i) adding all the polyester polyols and optional (meth)acrylic resins, and melting and mixing them until homogeneous and free of moisture,
(ii) adding at least one polyisocyanate, and mixing the mixture obtained under vacuum at 80° C. to 120° C. until the reaction is completed; and
(iii) adding catalyst and optional additives and stirring the mixture at 80° C. to 120° C. until homogeneous.

17. An electronic device, obtained with the high bio-content polyurethane hot melt adhesive composition according to claim 1.

18. (canceled)

19. The high bio-content polyurethane hot melt adhesive composition according to claim 1, wherein the bio-based solid crystalline polyester polyol derivative is the carboxylic anhydride and/or ester of the polyacid; and the polyacid is a diacid selected from the group consisting of succinic acid, azelaic acid, sebacic acid, dodecane dioic acid, dimer fatty acid, 2,5-furandicarboxylic acid, adipic acid and combinations thereof, and/or the polyol is a diol, which is selected from the group consisting of ethylene glycol, diethylene glycol, 1,2-propylene glycol, 1,3-propylene glycol, 1,4-butanediol, 1,6-hexane diol, isosorbide and combinations thereof.

20. The high bio-content polyurethane hot melt adhesive composition according to claim 1, wherein the bio-based solid amorphous polyester polyol is derived from a reaction mixture comprising at least one polyol and at least one polyacid; wherein the bio-based solid amorphous polyester polyol is derived from a reaction mixture comprising isosorbide, and at least one polyfunctional carboxylic acid selected from the group consisting of adipic acid, succinic acid, azelaic acid, sebacic acid, dodecandioic acid, tetradecane dioic acid, hexadecane dioic acid, octadecane dioic acid, furandicarboxylic acid, isophthalic acid, terephthalic acid, orthophthalic acid, dimerized fatty acid, trimerized fatty acid, and mixtures thereof.

21. The high bio-content polyurethane hot melt adhesive composition according to claim 1, wherein the bio-based liquid amorphous polyester polyol is derived from a reaction mixture comprising at least one polyol selected from the group consisting of 1,2-propanediol, 1,3-butanediol (including R-form, S-form and racemates), 1,4-pentanediol, 1,3-propylene glycol, 1,4-butanediol, 1,6-hexane diol, diethyleneglycol, triethyleneglycol, tetraethyleneglycol, polyethyleneglycol, dipropyleneglycol, and polypropyleneglycol or mixtures thereof.
